(19) United States
(12) Patent Application Publication
(10) Pub. No.: US 2007/0007783 A1
(43) Pub. Date: Jan. 11, 2007

(54) Loading space protection device having at least one winding shaft

(76) Inventor: Werner P. Schlecht, Vaihingen/Enz (DE)

Correspondence Address: FLYNN THIEL BOUTELL & TANIS, P.C., 2026 RAMBLING ROAD, KALAMAZOO, MI, 49008-1631, US

(21) Appl. No.: 11/483,970

(22) Filed: Jul. 10, 2006

(30) Foreign Application Priority Data
Jul. 11, 2005 (DE) 102005033819.4

(51) Int. Cl. B60R 7/04

(52) U.S. Cl. 296/24.4; 296/37.16

(57) ABSTRACT

A loading space protection device includes at least one winding shaft which is rotatably mounted between two end caps, the end caps securing the unit composed of the winding shaft and end caps in vehicle-end securing receptacles. The winding shaft is surrounded, in a region between the end caps, by a housing which includes at least one outlet slot for a flexible planar structure which is secured on the winding shaft in such a way that it can be wound on and unwound. The end caps are configured in their end edge region which adjoins the housing in such a way that their external contour merges in an aligned fashion with the external contour of the housing. Plugs are provided at the end edge regions of the end caps and/or at corresponding end sides of the housing and permit the end caps to be attached to the housing in a centered fashion.

The invention relates to a loading space protection device having at least one winding shaft which is rotatably mounted between two end caps, the end caps having securing means for attaching the unit composed of the winding shaft and end caps in vehicle-end securing receptacles, and the winding shaft being surrounded, in a region between the end caps, by a housing which comprises at least one outlet slot for a flexible planar structure which is secured on the winding shaft in such a way that it can be wound on and unwound.

Such loading space protection devices are generally known and serve to separate the loading space from a passenger compartment and/or serve as a loading space cover which can cover the loading space approximately horizontally approximately at the parapet height of the vehicle. Such loading space protection devices have a cartridge housing in which, depending on the design, one or more winding shafts, on each of which a flexible planar structure is secured so as to be capable of being wound on and unwound, are rotatably mounted. In the embodiment of the loading space protection device as a retaining device which can be extended vertically in order to prevent a load from being thrown forward out of the loading space into the passenger compartment in the event of a severe deceleration of the vehicle as a result of full braking or as a result of a vehicle impact, the cartridge housing has a slot-shaped outlet opening which is open toward the top and through which a flexible planar structure in the form of a dividing net can be pulled out upward toward the inner roof lining. In the embodiment as a horizontally extendible loading space cover, the cartridge housing is provided with an outlet slot which is open toward the rear and through which a tarpaulin-like flexible planar structure can be pulled out approximately horizontally toward the rear and can be secured by its end to the vehicle in the rear region of the vehicle. Finally, an embodiment of a loading space protection device in which a vertically extendible retaining device and a horizontally extendible loading space cover are integrated in a common cartridge housing is also known. For this case, the cartridge housing has receptacle spaces for two winding shafts and is provided with an outlet slot toward the top and one toward the rear. In all the embodiments, the cartridge housing is provided, at opposite end sides, with two end caps which are also referred to as housing side parts. These serve, on the one hand, to close off the cartridge housing at the end sides, and, on the other hand, to provide attachment means in order to permit the cartridge housing to be mounted to and removed from the vehicle in securing receptacles which are fixed to the vehicle, preferably in the parapet region of the passenger compartment of the vehicle. These end caps engage axially over the cartridge housing and are attached to the cartridge housing by rivet connections. It is also known to mount one of the two end caps in an axially movable fashion on the cartridge housing. This embodiment is used when the cartridge housing is fixed axially in the corresponding securing receptacles on the vehicle. For this purpose, the movable end cap is pressed coaxially outward with respect to the longitudinal axis of the housing by spring force, as a result of which corresponding attachment means of the end caps dip into corresponding recesses in the securing receptacles on the vehicle in a positively locking fashion. The cartridge housing is easily removed by pushing the end cap axially onto the housing, as a result of which the overall length of the protection device is reduced and the cartridge housing thus comes free from the securing receptacles on the vehicle. The known cartridge housings have the same cross section over their entire length and are preferably manufactured from extruded sections.

The object of the invention is to provide a loading space protection device of the type mentioned at the beginning which permits better adaptation to the configuration of the passenger compartment of the vehicle.

This object is achieved in that the end caps are configured in their end edge region which adjoins the housing in such a way that their external contour merges in an aligned fashion with the external contour of the housing, and that plugging means are provided at the end edge regions of the end caps and/or at corresponding end sides of the housing and permit the end caps to be attached to the housing in a centered fashion. As a result it is possible to attach the end caps to the housing in an aligned and flush fashion so that a uniform appearance is produced for the loading space protection device over its entire external contour. The end caps are thus integrated optically into the overall appearance of the loading space protection device. As a result it is possible to adapt the cartridge housing, including its end caps, to corresponding design requirements for the configuration of the passenger compartment of the vehicle. The plugging means simultaneously ensure that the end caps are securely centered and positioned on the housing.

In one refinement of the invention, the plugging means comprise receiving edges on the housing which are offset toward the inside, and each end cap has corresponding plugging faces which can be plugged onto the respective receiving edge on the outside. As a result it is advantageously possible to plug the end cap onto the corresponding end side of the housing in an aligned and flush fashion and to provide reliable positioning of the end cap.

According to one advantageous refinement of the invention, securing means which secure each end cap axially in its mounted state in which it is attached to the housing are assigned to the plugging means. As a result, additional attachment means can advantageously be avoided. The securing means may be formed on in one piece to the housing or to the corresponding end cap, in particular in the form of latching projections and latching cutouts.

In a further refinement of the invention, the receiving edges have a step on the inside of the housing and each end cap is plugged axially into the step. In this embodiment, the respective end cap is pushed axially into the housing by its plugging faces. Of course the aligned connection of the end cap, which is also flush with the external contour, is also ensured in this embodiment.

In a further refinement of the invention, at least one end cap is guided in an axially movable fashion in relation to a longitudinal axis of the housing by means of guide faces, and at least one end stop which bounds the axial mobility of the end cap in relation to the housing is provided. The end stop can also serve as a securing means in the sense of the invention. This embodiment can advantageously be used in loading space protection devices in which the housing is mounted and removed by means of axially spring-loaded movement of at least one end cap. A corresponding end stop is advantageously formed on in one piece to the end cap. For this purpose, the at least one end cap is manufactured from plastic.

In a further refinement of the invention, the end caps and the winding shaft are embodied in a load-receiving fashion. In this embodiment, the two end caps and the winding shaft together with the bearing of the winding shaft in the end cap form the supporting structure for the loading space protection device. The housing itself does not need to perform any load-bearing or supporting function and can consequently be configured exclusively according to visual and design criteria.

In a further refinement of the invention, the winding shaft is embodied in a dimensionally stable fashion such that it serves as a crossmember for receiving force from side impact loads in the transverse direction of the vehicle. In addition to the winding shaft, the end caps are advantageously also attached in the loading space, preferably in side parapets of the passenger compartment of the vehicle, in such a stable fashion that when a side impact load occurs in an end cap region there is a force flux from this end cap through the winding shaft to the opposite end cap and into the opposite parts of the supporting structure of the bodywork there. In such an embodiment, the winding shaft is advantageously arranged in the securing receptacles of the lateral parapet only with an extremely small degree of axial play so that the corresponding force flux can form. In a further refinement it is possible to configure the winding shaft from a material which can be deformed plastically, at least in certain sections, in order to permit additional absorption of energy as a result of deformation of the winding shaft if a corresponding side impact occurs.

In a further refinement of the invention, the housing is manufactured from plastic in one or more parts. The housing is preferably composed of an upper shell and a lower shell, as a result of which, in a particularly advantageous way, the external contour of the housing can be configured by means of free-form faces. The multi-shell design of the housing permits the housing to be configured predominantly according to design criteria without compromising the possibility of series production of the housing using the plastic injection molding method.

Further advantages and features of the invention emerge from the claims and from the following description of preferred exemplary embodiments of the invention which are illustrated with reference to the drawings, in which:

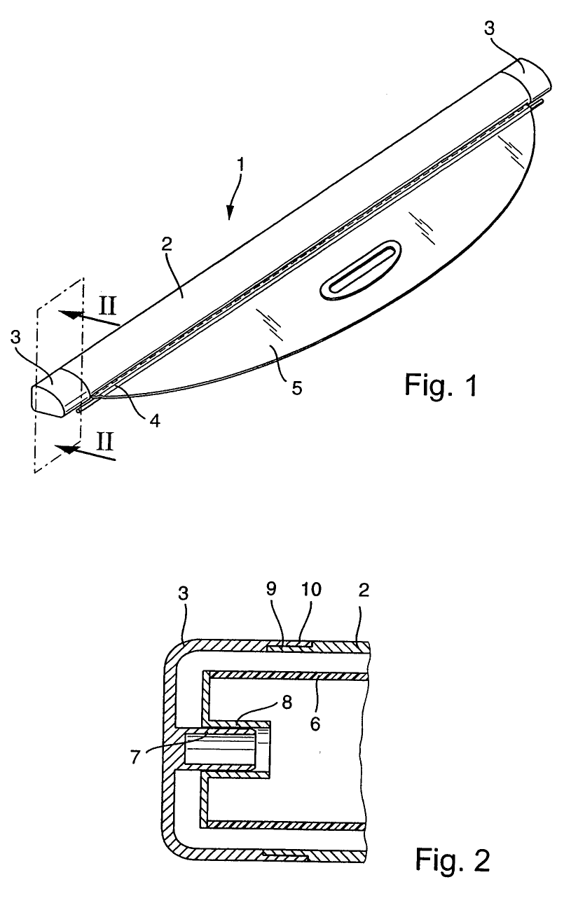

FIG. 1 shows a perspective view of a first embodiment of a loading space protection device according to the invention in the form of a loading space cover,

FIG. 2 shows a detail of the loading space cover according to FIG. 1 along the sectional plane II-II in FIG. 1,

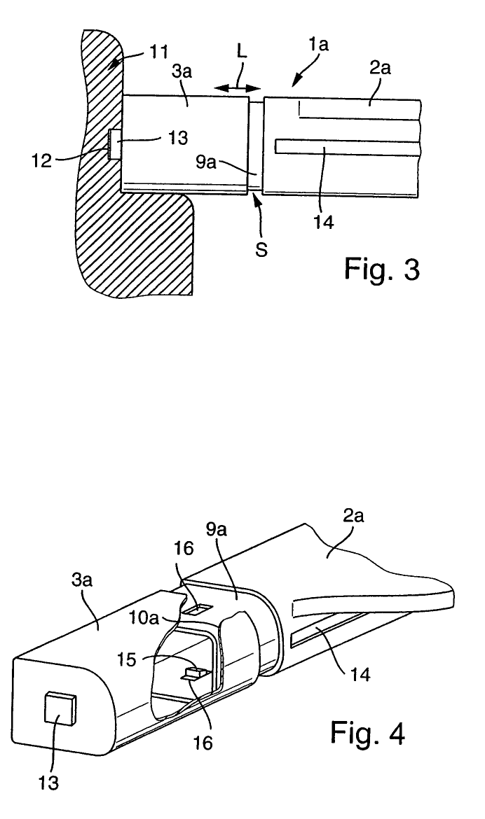

FIG. 3 is an enlarged schematic illustration of a detail of a further loading space protection device according to the invention in the region in which it is mounted on a side parapet on the vehicle,

FIG. 4 shows the loading space protection device according to FIG. 3 in a perspective, partially cut-away illustration,

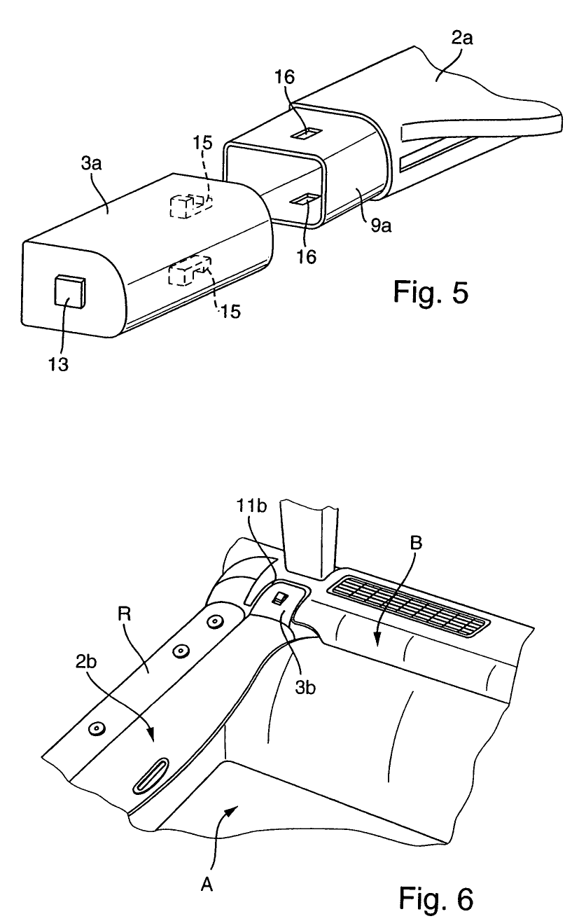

FIG. 5 shows an exploded view of the loading space protection device according to FIG. 4, and

FIG. 6 shows a perspective illustration of a detail of a passenger compartment of a vehicle which is provided with a further embodiment of a loading space protection device according to the invention.

A loading space protection device in the form of a loading space cover 1 which can be pulled out horizontally has, according to FIGS. 1 and 2, a housing in the form of a cartridge housing 2 which, in the mounted state, extends within a loading space of an estate passenger car, in the transverse direction of the vehicle. Such a cartridge housing 2 is arranged, in a basically known fashion, approximately at the level of a sill line of a vehicle directly behind a rear bench seat of a passenger compartment of the vehicle. A winding shaft on which a flexible planar structure, preferably in the form of a covering tarpaulin, is secured in such a way that it can be wound on and unwound is rotatably mounted in the cartridge housing 2. The cartridge housing 2 has a pull-out slot which extends virtually over the entire length of the cartridge housing 2 and through which the flexible planar structure can be pulled out approximately horizontally in the rearward direction toward a rear part of the motor vehicle and thus toward the loading space. In order to pull out the planar structure, a pull-out bar 4 is provided in a basically known fashion at the front end of said planar structure in the pulling out direction, said pull-out bar 4 extending over the entire width of the planar structure and a dimensionally stable contour part 5 being integrally formed on it. The dimensionally stable contour part 5 is provided with a through-opening which can have a closure lid in a basically known fashion.

An end cap 3 is provided on each of the opposite end sides of the cartridge housing 2 as side part of the housing, said end caps 3 being attached in an aligned fashion to the external contour of the cartridge housing 2, and flush with their external contour. The end caps 3 are provided with attachment means, in a way which is not illustrated in more detail, in order to be able to secure the cartridge housing 2, including the end caps 3, to the vehicle in the lateral parapets of the loading space. In an exemplary embodiment which is not illustrated, the attachment means can also be arranged directly on the cartridge housing. In such an embodiment, the loading space cover 1 is preferably attached to the rear side of the rear bench seat. In such an embodiment, the end caps do not have any attachment function for the cartridge housing.

In all cases, as in the embodiment according to FIGS. 1 and 2, the end caps 3 are provided for rotatably mounting a winding shaft 6 in the region of its opposite end sides, said winding shaft 6 extending in the interior of the cartridge housing 2. The flexible planar structure is secured on the winding shaft 6 and mounted in such a way that it can be wound on and unwound. In a way which is not illustrated in more detail, a winding-on spring is provided within the winding shaft 6, said winding-on spring exerting a torque on the winding shaft 6 in the winding-on direction in order to permit the planar structure to be wound automatically onto the winding shaft 6 as soon as a correspondingly counteracting tensile load on the pull-out bar 4 and the contour part 5 of the planar structure is removed.

A journal 7, which projects coaxially inward with respect to the winding shaft 6, is formed on in one piece on the inside of an end face of the end cap 3 in order to provide a rotatable bearing for the winding shaft 6. A corresponding bearing sleeve 8, which is fitted onto the journal 7 in a slide-mounted fashion, is assigned to the winding shaft 6 itself at the end.

So that the end cap 3 which finishes aligned and flush with the external contour of the cartridge housing 2 can be joined onto the cartridge housing 2, the corresponding end side of the cartridge housing 2 is provided with a circumferential receiving edge 9 which is offset inward in the manner of a step compared to the visible external contour of the cartridge housing 2, and in the embodiment according to FIG. 2 has approximately half the wall thickness of the wall of the cartridge housing 2. The end cap 3, whose wall thickness corresponds to that of the cartridge housing 2, is provided, in its end face region facing the receiving edge 9 of the cartridge housing 2, with a corresponding plugging edge 10 which is configured as a flush projection of the wall of the end cap 3, but has merely approximately half the wall thickness of the wall of the end cap 3. The plugging edge 10 is matched to the receiving edge 9 of the cartridge housing 20 in order to permit the end cap 3 to be plugged onto the receiving edge 9 of the cartridge housing 2 in a positively locking fashion. In addition, a securing means can be provided (in a way which is not illustrated in more detail) in order to secure the end cap 3 in its position in which it is plugged onto the cartridge housing 2.

The end cap 3 corresponds in its cross section and in its external contour to the cross section and the external contour of the cartridge housing 2 so that the end caps 3 constitute the end projections of the cartridge housing 2 without projecting radially beyond the external contour of the cartridge housing 2.

In the embodiment according to FIGS. 3 to 5, a loading space protection device 1a is provided, preferably in the form of a loading space cover, in which an end cap 3a is joined onto a cartridge housing 2a in such a way that in the connecting region it adjoins the cartridge housing 2a, or its external contour, with its external contour in a flush fashion. The significant difference compared to the embodiment according to FIGS. 1 and 2 is that in the embodiment according to FIGS. 3 to 5 one of the two end caps 3a, specifically the end cap 3a illustrated in FIGS. 3 to 5, is additionally mounted in a limited axially movable fashion (double arrow L). This axial mobility serves to mount the cartridge housing 2a including its two end caps 3a in securing receptacles 11 on the vehicle, on the parapet of the loading space, and to remove them.

In order to be able to move the end cap 3a in the direction of the arrow L in a limited axially movable fashion coaxially with respect to the longitudinal axis of the cartridge housing 2a and thus coaxially with respect to the longitudinal axis of the winding shaft, the circumferential receiving edge 9a of the cartridge housing 2a is extended so that, in addition to its plugging and centering function, it performs an axial guiding function for the end cap 3a. In a correspondingly reversed fashion, the end cap 3a is provided over at least the majority of its axial length with a reduced wall thickness in order to permit the end cap 3a to be plugged onto the receiving edge 9a in an aligned and flush fashion. The corresponding plugging and guide faces on the inside of the end caps 3a are provided with the reference symbol 10a.

In order to additionally limit the axial mobility of the end cap 3a on the receiving edge 9a of the cartridge housing 2a and at the same time to secure the end cap 3a to the cartridge housing 2a, latching projections 15 are provided both in the region of the upper side of the inside of the said end cap 3a and in the region of its underside, said latching projections 15 engaging in corresponding, slot-shaped guiding cutouts 16 in the receiving edge 9a. The guiding cutouts 16 extend parallel to the longitudinal axis of the cartridge housing 2a and have such a large length that the respective latching projection 15 is arranged in the corresponding guiding cutout 16 so as to be axially displaceable by a certain amount.

At an outer end of the end cap 3a, the end cap 3a is provided with a securing tappet 13 which, in the mounted state, engages in a corresponding securing cutout 12 in the securing receptacle 11 on the vehicle. The amount of the axial length by which the end cap 3a is axially movably mounted (double arrow L) corresponds at least to the depth of the securing cutout 12 in order to permit the cartridge housing 2a including the end caps 3a to be mounted and removed. In a way which is not illustrated in more detail, an axial compressive force which is preferably applied by a spring and which keeps the end cap 3a in the axially outer end position (FIG. 3) in the unloaded state acts on the end cap 3a. By manually pressing the end cap 3a toward the center of the cartridge housing, the cartridge housing 2a including the end caps 3a can be removed from the securing receptacles 11 on the vehicle.

A longitudinal slot 14 which serves as an outlet opening for the flexible planar structure is provided in the cartridge housing 2a.

The joint S which can be seen in FIG. 3 corresponds in its width to the axial travel which the end cap 3a can carry out at maximum from the position according to FIG. 3 in the axial direction toward the cartridge housing 2a.

The latching projections 15 are of elastically resilient design such that for initial mounting the end cap 3a can be plugged axially onto the receiving edge 9a and latched into the guiding cutouts 16. The end caps 3a can be basically released again from the cartridge housing 2a by correspondingly pressing inward on the latching projections 15, but this can only be carried out with considerable effort owing to the structural restrictions. The latching projections 15 are arranged on the inside of the inner wall of the end cap 3a and are provided on the end sides of web-like latching limbs which project toward the cartridge housing 2a, parallel to the inner wall of the end cap 3a.

The embodiment according to FIG. 6 corresponds to the previously described embodiments in terms of the basic arrangement of the cartridge housing 2b. In the embodiment according to FIG. 6, the cartridge housing 2b is also provided on the back of a backrest arrangement R of a rear bench seat and extends horizontally in the transverse direction of the vehicle, approximately at the level of a sill line of the vehicle. In addition, it is secured in opposite side parapets B on the vehicle. The cartridge housing 2b has a flexible planar structure which functions as a loading space cover and extends approximately horizontally over the loading space A in the pulled-out state. The end caps 3b of the cartridge housing 2b also end aligned and flush with the external contour of the cartridge housing 2b in their joint region 4 or connection region with the corresponding end side of the cartridge housing 2b. The significant difference in the embodiment according to FIG. 6 is that in the said embodiment there is no provision of axial mobility of the end cap 3b but instead both end caps 3b are attached to the cartridge housing 2b in an axially secured fashion. Both end caps 3b have locking means in order to permit the end caps 3b to be secured or released in the securing receptacles 11b of the respective parapet B on the vehicle. As is apparent from FIG. 6, the locking means are provided with actuating knobs (not designated in more detail) which make it possible to unlock the locking means.

1. Loading space protection device having at least one winding shaft which is rotatably mounted between two end caps, the end caps having securing means for attaching the unit composed of the winding shaft and end caps in vehicle-end securing receptacles, and the winding shaft being surrounded, in a region between the end caps, by a housing which comprises at least one outlet slot for a flexible planar structure which is secured on the winding shaft in such a way that it can be wound on and unwound, wherein the end caps are configured in their end edge region which adjoins the housing in such a way that their external contour merges in an aligned fashion with the external contour of the housing and the plugging means are provided at the end edge regions of the end caps and/or at corresponding end sides of the housing and permit the end caps to be attached to the housing in a centered fashion.

2. Loading space protection device according to claim 1, wherein the plugging means comprise receiving edges on the housing which are offset toward the inside, and each end cap has corresponding plugging faces which can be plugged onto the respective receiving edge on the outside.

3. Loading space protection device according to claim 1, wherein the receiving edges have a step on the inside of the housing, and each end cap is plugged axially into the step.

4. Loading space protection device according to claim 1, wherein securing means which secure each end cap axially in its mounted state in which it is attached to the housing are assigned to the plugging means.

5. Loading space protection device according to claim 1, wherein at least one end cap is guided in an axially movable fashion in relation to a longitudinal axis of the housing by means of guide faces and at least one end stop which bounds the axial mobility of the end cap in relation to the housing is provided.

6. Loading space protection device according to claim 1, wherein the end caps and the winding shaft are embodied in a load-receiving fashion.

7. Loading space protection device according to claim 6, wherein the winding shaft is embodied in a dimensionally stable fashion such that it serves as a crossmember for receiving force from side impact loads in the transverse direction of the vehicle.

8. Loading space protection device according to claim 1, wherein the housing is manufactured from plastic in one or more parts.

9. Loading space protection device according to claim 8, wherein the external contour of the housing is formed by means of free-form faces.
